(19) United States
(12) Patent Application Publication
(10) Pub. No.: US 2007/0218437 A1
(43) Pub. Date: Sep. 20, 2007

(54) Heart model for training or demonstrating heart valve replacement or repair

(76) Inventors: Vincent Ercole Lotano, Cherry Hill, NJ (US); Elena Mariana Lotano, Cherry Hill, NJ (US)

Correspondence Address: BLANK ROME LLP, 600 NEW HAMPSHIRE AVENUE, N.W., WASHINGTON, DC, 20037, US

(21) Appl. No.: 11/366,579

(22) Filed: Mar. 3, 2006

(51) Int. Cl. G09B 19/00

(52) U.S. Cl. 434/236

(57) ABSTRACT

The present invention relates to heart models for surgical training and/or demonstration. More particularly, the present invention relates to heart models, which incorporate features to simulate visual and manipulation of heart valves, to be used as training and/or demonstration subjects for heart valve replacement surgery. The simulated valves may be removable inserts, that are replaceable and disposable, attached to a support platform.

### FIELD OF THE INVENTION

The present invention relates to heart models for surgical training and/or demonstration. More particularly, the present invention relates to heart models, which incorporate features to simulate visual and manipulation of heart valves, to be used as training and/or demonstration subjects for heart valve replacement surgery.

### BACKGROUND OF THE INVENTION

Optimal function of the heart requires healthy valves. Versatility of medical and surgical procedure has tremendously increased in recent years with it now being quite possible to treat certain medical ailments and defects that, previously, were considered untreatable. For example, it is now possible to surgically repair many cardiac defects, including defective heart valves. Modern medicine is now able to repair or replace defective heart valves by surgical methods. Causes of heart valve malfunction include obstruction to flow (valvular stenosis), leakage (valvular insufficiency), or a combination of both (mixed valve disease), which can be repaired by corrective surgery, which include valve repair or replacement with cryopreserved human valves (homografts), valves made from treated animals' tissues (xenografts) or valves manufactured from metals and other man-made materials (mechanical valves). While these procedures are having a beneficial effect on the medical condition of cardiac patients in general, the success of any particular cardiac procedure is linked to the training and experience of the doctors performing the operation.

Currently, the best method for a cardiac surgeon to obtain experience in performing medical procedures on the human heart, such as heart valve replacement, is by actually performing a procedure on a live patient under supervision of an experienced surgeon. However, for obvious reasons this is not the most desirable method for teaching surgical techniques to new surgeons. The use of a cadaver, human or animal, model offers an alternative to the live training method, and provides the opportunity to work on a real heart. However this approach also has many disadvantages. Working on a cadaver is unrealistic because the heart tissues are not identical to the tissues of live heart and the movement associated with contractions of the myocardium is obviously missing. Additionally, cadavers are expensive and are generally in short supply. Moreover, a cadaver heart can be used only for a very limited number of procedures. Finally, the handling of cadavers is often stringently regulated by governmental agencies, and requires cumbersome administration.

Other technological alternatives for training on real bodies have been suggested, but are all deficient in that they do not adequately address the particular problems of heart valve replacement. For example, U.S. Pat. No. 6,234,804 to Yong teaches a model thorax with an internal cavity enclosing a replica of a heart. While the heart device is equipped to simulate bleeding or blood flow and pressurized circulation through the heart, there is no mechanism for providing valve replacement surgery. Thus, the device does not provide a realistic tool for medical procedures intended to be performed on a heart valve.

Other heart models in the prior art include U.S. Pat. No. 5,149,270 to McKeown, U.S. Pat. No. 5,634,797 to Montgomery, U.S. Pat. No. 5,947,744 to Izzat, U.S. Pat. No. 6,062,866 to Gerrits et al., U.S. Pat. No. 6,685,481 to Chamberlain, U.S. Pat. No. 6,780,016 to Toly, U.S. Patent Publication No. 2001/0019818 to Young, and U.S. Patent Publication No. 2005/0084834 to Baldauf, all of which are incorporated herein by reference. These other cardiac models, however, are similarly deficient in that they fail to provide a model capable of simulating the particular problems of heart valve replacement. Therefore, there remains a need for a heart model that realistically and specifically simulates the heart valves for practicing and/or demonstrating the techniques of heart valve replacement surgeries.

### SUMMARY OF THE INVENTION

The present invention is a heart model which serves as a demonstration and/or training device for surgeons and medical personnel in performing heart valve replacement and/or repair. The model is also a testing device for new valve replacement technologies and devices.

The model includes a simulated heart or part thereof and contains, at a minimum, relevant structures and configurations of at least a heart valve. The model may also include other peripheral structures that are relevant to the particular surgical procedure of replacing and/or repairing the valve. The model may be a partial model that contains only one valve or all the valves of the heart or any number therebetween. The relevant valves include the aortic valve, the mitral valve, the tricuspid valve, and/or the pulmonary valve.

In one embodiment, the valve(s) is included as removable and replaceable insert(s) of the heart model. Here, the heart model is constructed to accept one or multiple insertions, which are parts of the model that can be replace after each use. In this way, the model can be reused after each practice or demonstration session by replacing the particular valve that has been destroyed or modified by the surgical procedure.

The model is structured in appearance and size to closely simulate the anatomy of the heart in a human. The model may include veins and a circulation system, particularly those that are essential in the particular surgical procedure being considered. The various veins and arteries are fabricated from tubing, preferably from flexible polymeric tubing, such as silastic, rubber, and silicone. Any tubing that is flexible enough to simulate a vein or artery is appropriate for the present invention.

### BRIEF DESCRIPTION OF THE DRAWINGS

The foregoing background and summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a drawing showing the aortic valve insert of the present invention.

FIG. 2 is a drawing showing the stent valve used in the Bentall procedure.

FIG. 3 is a drawing showing the stent valve attached to the aortic valve insert after the Bentall procedure.

FIG. 4 is a drawing of a stentless valve inserted into the aortic valve insert.

FIG. 5 is a drawing of a stentless valve.

### DETAILED DESCRIPTION OF THE PREFERRED EMBODIMENT

The heart model is preferably constructed and arranged to conform in anatomical details to an actual human heart. The heart model may be made with different sizes, shapes, colors, etc. to simulate an adult or a pediatric heart. Moreover, the heart model may also simulate either a healthy or a diseased heart, as required. The heart model is preferably formed with cavities that simulate respectively the right and the left atria and ventricles. These chambers include valves simulating actual details of the actual valves, including the aortic, mitral, tricuspid, and/or pulmonary valves. In this embodiment the heart model may or may not be animated.

The heart model may be made of silicone, typically having a thickness of about 3/16 to ⅜ inches. The heart model may also be manufactured from other suitable materials, e.g., synthetic plastic such as polyethylene terephthalate, polyvinyl chloride, etc. Another suitable material includes the plastic manufactured under the trade name “Friendly Plastic” by American Art Clay Co., Inc., Indianapolis, Ind. The various components may also be colored to enhance comprehension of the various surgical steps taking place. Silicone tubing having a diameter of about ⅛″ may also be attached to the heart model to simulate arteries. These tubes may be filled with a red colored liquid to simulate blood. Preferably, the materials used to make the heart model closely simulate the heart muscle and various tissues, especially the valves and their associated structures, to effect a realistic model or demonstration.

In one embodiment, the heart model simulates a partial heart with only the valve or valves being demonstrated or practiced on present. This embodiment simulates a cut away portion of the heart exposing the particular valve or valves.

In a preferred embodiment, the heart model contains markings, such as, but not limited to, suture lines, cut lines, and alignment markings. These markings instruct the surgeon and demonstrator the locations, for example of sutures and cutting, and/or alignment of the replacement valve in the heart. The cut lines instruct where to excise the defective heart valve and what to remove from the heart prior to fitting and seating of the replacement valve or repair prosthesis. The alignment markings shows how the replacement valve should be aligned and seated; and the suture lines instructs where sutures should be placed to secure the replacement valve in place without leakage. Other markings may also be present, such as on the replacement valves (stented or stentless) or rings to help align the prosthesis.

In yet another embodiment, the heart model contains valve insert(s) that are removable and replaceable. In this embodiment, the model contains two parts: the insert or inserts, and a support platform. The support platform may be a whole or partial heart model, or a simple box holding the insert in place. This insert embodiment allows the support platform of the heart model to be reused, while the valve portion, that is subjected to modification or destruction by the medical procedure being practiced or demonstrated, is replaceable. Here, the support platform is constructed to accept one or multiple inserts, which are parts of the model that can be replaced after each use. The insert may be attached to the support platform of the heart model by friction, by pressure by firmly pushing it into place, or by any known locking mechanisms. Preferably, the insert is designed so that it snaps into a void or hole in the support platform of the heart model to hold therein by friction. To remove the insert, the void is deformed to release the insert from the support platform.

Although conformity in anatomical details to an actual human heart is most desired, the insert need not be used with a model that perfectly simulates the heart, as long as the insert sufficiently simulates the valve and its associated structure to realistically convey a meaningful and satisfactory practice or demonstration. Further, if an insert is used, only the insert needs to be flexible to simulate real heart valve structures. The reset of the heart may be made of more durable material, such as polycarbonate, polyvinylchloride (PVC), and the like. In the simplest version, the insert may be attached to an empty structure, such as a simple box, which exemplifies the rest of the heart, while only the insert has all the necessary structures of the heart to perform a simulated heart valve replacement or repair and to demonstrate or practice sizing of the annulus or leaflet before replacing or repairing of the valves.

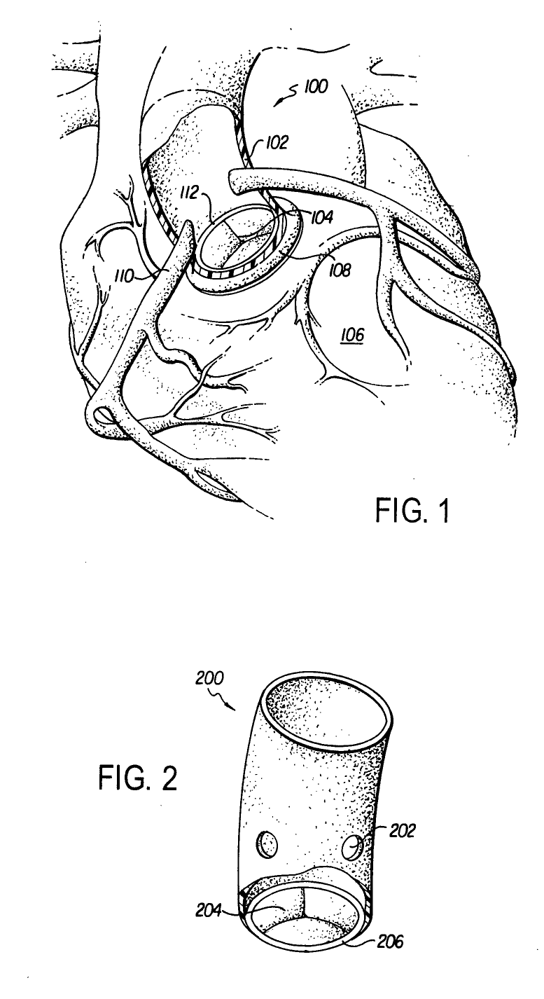

An insert for simulating an aortic valve replacement is depicted in FIG. 1. The aortic insert (100) contains a generally tubular segment (102) simulating the aorta. Inside of the tubular segment (102) is the aortic valve (104) which encircled by the aortic annulus (112). The aortic annulus (112) can generally be formed of a thickened section of material simulating the actual aortic tissue. The insert (100) is removably mounted on a support platform (106) having an opening (108) where the insert (100) attaches by friction. The aortic insert (100) also contains coronary arteries (110) that are attached to the aortic insert (100) downstream of the valve (distal to the valve). Those coronary arteries (110) may be attached to the rest of the heart model, for example via a tubular protrusion where the arteries (110), which made of soft plastic tubing is stretched to securely fit around the protrusion. The other end of the arteries (110) are sewn to the insert (100). In a preferred embodiment, the aortic annulus (112) and valve (104) are formed of soft material (the same material that the tubular aorta (102) is made of) that is interspersed with hard material to simulate calcified segments of the annulus (112).

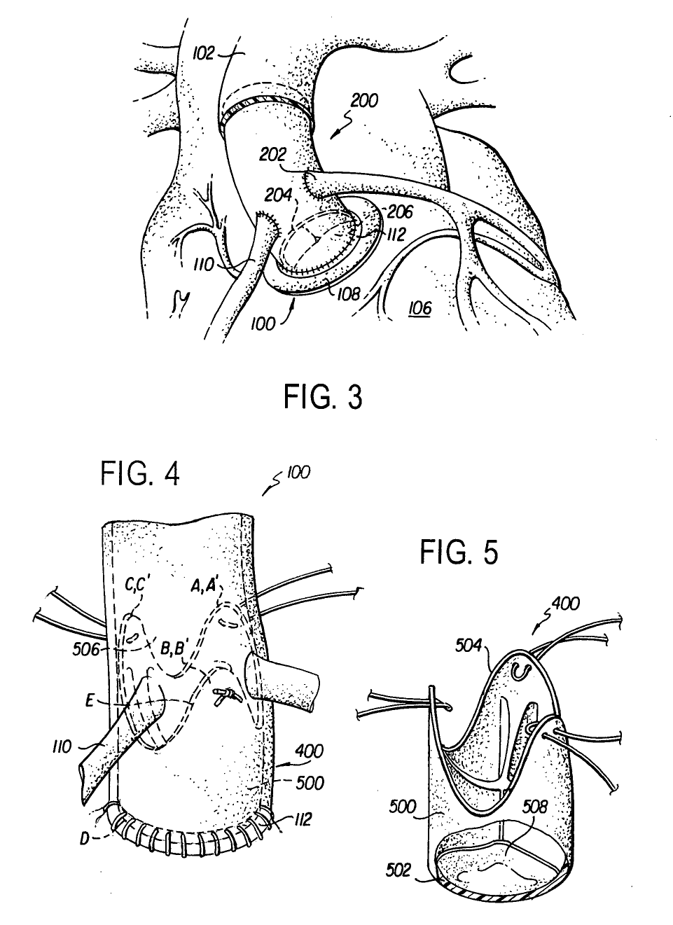

During the practice or demonstration session, the surgeon excises the leaflets of the aortic valve (104) leaving behind the aortic annulus (112). A prosthetic valve can then be sewn in place to replace the excised valve. For example, if the modified Bentall procedure is used, other than the leaflets of the aortic valve (104), the surgeon has to also properly excise the coronary arteries (110) from the aorta (102). FIG. 2 shows the stent (200) used in the modified Bentall procedure. The stent (200) is generally a cylinder, made of dacron or hemashield (prosthetic graft material), having a prosthetic valve (204), usually made of pyrolytic carbon, on one end of the cylinder, and two holes (202) (made by the trainee) for attaching the coronary arteries (110). The prosthetic valve (204) is circumscribed at its circumference by a valve ring (206). The stent (200) is attached to the dissected insert (100) by sewing the valve ring (206) on to the remaining aortic annulus (112) on the dissected aortic insert (100). The coronary arteries (110) are then sewn to the holes (202) on the stent (200). The top of the stent (200) is then sewn to the simulated aorta. The finally attached stent is shown in FIG. 3.

Alternatively, other prosthetic valves, such as stentless valves, including mechanical and biological valves can be used with the model of the present invention. Biological valves may include xenografts, allografts, homografts, and autografts. Any existing and future developed valves may be practiced on the heart model of the present invention. Marking instructions on the heart model may vary according to the type of replacement valve being used. Another advantage of using the inserts is that these inserts can be custom marked to match the type of replacement valve or procedure being used, without having to develop a new heart model. For example, an insert designed specifically for the Bentall procedure may also include markings to show cutting lines so that the practicing surgeon/demonstrator knows where to excise the valve and the coronaries. Further, markings may also be present to show where to suture the stent to the aorta.

FIG. 4 shows a stentless valve (400) inserted into the aortic insert (100). A stentless valve (400) is depicted in FIG. 5, which may be, e.g., a pig aortic valve. The stentless valve (400) contains a generally tubular wall (500) having a base (502) and a scalloped top (504) so that the wall (500) in the scallop do not block the coronary arteries (110). The actual valve mechanism (508) of the prosthesis is located insider the cylinder.

During the practice session, after the leaflets of the aortic valve are excised as discuss above, the base (502) of the stentless valve (400) is sewn to the aortic annulus (112). Prior to sewing the base in place, however, the valve (400) must properly be seated so that the coronaries match with the depressions in the scalloped top (504). During training, this may be accomplished by aligning the markings on the valve (400) with those on the insert. For example, as shown in FIG. 4, to properly align the prosthetic valve (400), markings A, B, and C on the insert (100) should match the markings A′, B′, and C′ on the prosthetic valve (400). The prosthetic valve (400) is then properly seated to the base (502) by sewing the aortic annulus along suture markings D; and the raised portion of the scalloped top (504) is sutured to the aorta at markings A, B, and C. Subsequently, the whole top (504) is sutured to the aorta along its full circumference along suture line E.

Although the above discloses an insert for an aortic valve, the particular structures need not be in an insert, but can be engineered directly into the heart model. This way, however, the model heart cannot be reused. Further, the model may be made so that the valve has already been excised, so that the procedure of seating and inserting the prosthetic valve can be practiced by a surgeon without having to first excise the valve leaflets.

Although the above discloses the aortic valve as a preferred embodiment, other valves, such as the mitral valve, tricuspid valve, and/or pulmonary valve, may be present in the heart model. These other valves may be an integral part of the model, or preferably, a removable/replaceable insert as discussed above. For example, the mitral valve insert may represent a malfunction valve so that the surgeon can practice repair procedures, such as insertion of an anuloplasty ring, or replacement procedures. With the mitral valve, the insert preferably contains other valvular associated structures, such as the chordae, papillary muscle, and calcification, in the valve insert to realistically simulate the actual valve and surgical procedure. The design and construction of other valve inserts would be apparent to one skilled in the art from the present disclosure.

In an embodiment, the heart model may be placed within a replica thorax. The replica thorax may be a simple box, as disclosed in U.S. Pat. No. 5,947,744, or a life like replica of a human chest. Preferably, the thorax is an typical-sized adult male chest intended to represent a patient lying on his back from the neck to diaphragm and shoulder to shoulder. This embodiment best simulates the closed chest so a trainee could be trained with a robot or robotic tools for valve repair or replacement. The replica thorax preferably has the model secured inside and has access ports, simulating openings or incisions, for the robot or robotic tools to access the model heart.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A heart model for practicing or demonstrating heart valve replacement or repair surgery comprising a support portion and at least one insert removably coupled to the support portion, wherein the insert simulates structures of a heart valve.

2. The heart model of claim 1, wherein the heart valve is an aortic valve, a mitral valve, a tricuspid valve, or a pulmonary valve.

4. The heart model of claim 1, wherein the support portion is shaped to resemble a heart or part thereof.

5. The heart model of claim 1, wherein the model further comprises tubing to resemble arteries.

6. The heart model of claim 1, wherein the structures of the heart valve simulating those of a diseased valve.

7. The heart model of claim 1, fabricated from plastic.

8. The heart model of claim 1, further comprising markings to assist a user in performing a valve replacement or repair demonstration.

9. The heart model of claim 8, wherein the markings include a cutting line, a suture line, or an alignment mark.

10. A method for making a heart model comprising the steps of
providing a support portion; and
attaching a removable insert to the support portion, wherein the insert simulates structures of a heart valve.

11. The method of claim 10, wherein the heart valve is an aortic valve, a mitral valve, a tricuspid valve, or a pulmonary valve.

12. The method of claim 10, wherein the support portion is shaped to resemble a heart or part thereof.

13. The method of claim 10, wherein the model further comprises tubings to resemble arteries.

14. The method of claim 10, wherein the structures of the heart valve simulating those of a diseased valve.

15. The method of claim 10, fabricated from plastic.

16. The method of claim 10, wherein the support portion resembles a portion of a heart.

17. The method of claim 10, further comprising markings to assist a user in performing a valve replacement or repair demonstration.

18. The method of claim 10, wherein the markings include a cutting line, a suture line, or an alignment mark.
